(19) United States
(12) Patent Application Publication
(10) Pub. No.: US 2010/0238370 A1
(43) Pub. Date: Sep. 23, 2010

(54) LIQUID CRYSTAL DISPLAY DEVICE AND MANUFACTURING METHOD THEREOF

(75) Inventor: Shohei Matsumoto, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/702,943

(22) Filed: Feb. 9, 2010

(30) Foreign Application Priority Data
Mar. 23, 2009 (JP) 2009-069706

(51) Int. Cl. G02F 1/1333; H01J 9/20

(52) U.S. Cl. 349/58; 445/24

(57) ABSTRACT

A curved-surface-type liquid crystal display device suitable for reduction of thickness and weight of such a display device is provided. A liquid crystal display device includes: a liquid crystal display panel which is formed by sandwiching liquid crystal between a first substrate and a second substrate; a first polarizer which is adhered to a viewer's-side surface of the liquid crystal display panel; a second polarizer which is adhered to a surface of the liquid crystal display panel on a side opposite to the viewer's-side surface of the liquid crystal display panel; and a frame which houses the liquid crystal display panel therein, wherein the liquid crystal display panel is formed into a curved shape in a direction that the viewer's-side surface of the liquid crystal display panel forms a convex surface or a concave surface in a state where the liquid crystal display panel is not housed in the frame.

### CROSS-REFERENCE TO RELATED APPLICATION

The present application claims priority from Japanese application JP 2009-069706 filed on Mar. 23, 2009, the content of which is hereby incorporated by reference into this application.

### BACKGROUND OF THE INVENTION

1. Field of the Invention

The present invention relates to a liquid crystal display device, and more particularly to a technique which is effectively applicable to a liquid crystal display device (liquid crystal display module) having a polarizer on a viewer's side surface of a liquid crystal display panel and on a surface of the liquid crystal display panel opposite to the viewer's side surface.

2. Background Art

A TFT (Thin Film Transistor)-type liquid crystal display module having a miniaturized liquid crystal display panel for color display in which the number of sub pixels is approximately 240×320×3 has been popularly used as a display part of portable equipment such as a mobile phone.

The liquid crystal display module which is used as the display part of the portable equipment such as the mobile phone includes: a liquid crystal display panel; a first polarizer which is adhered to a viewer's side surface (display screen) of the liquid crystal display panel; and a second polarizer which is adhered to a surface (back surface) of the liquid crystal display panel opposite to the viewer's side surface (display screen). Further, the liquid crystal display module includes a resin mold frame, for example, as a frame for housing the liquid crystal display panel.

The liquid crystal display panel is constituted of a first substrate, a second substrate, and a liquid crystal layer which is sandwiched between the first substrate and the second substrate. The above-mentioned first polarizer is adhered to a surface of the first substrate of the liquid crystal display panel on a side opposite to a liquid-crystal-layer side of the first substrate of the liquid crystal display panel with an adhesive layer interposed therebetween, and the above-mentioned second polarizer is adhered to a surface of the second substrate of the liquid crystal display panel on a side opposite to a liquid-crystal-layer side of the second substrate of the liquid crystal display panel with an adhesive layer interposed therebetween.

The liquid crystal display module having the polarizer formed on the viewer's side surface of the liquid crystal display panel and the polarizer formed on the surface of the liquid crystal display panel opposite to the viewer's side surface is disclosed in JP-A-2007-25484 (corresponding US Patent Laid-open Publication 2007/0019127) (patent document 1).

### SUMMARY OF THE INVENTION

Here, as the liquid crystal display module, there has been known a curved-surface-type liquid crystal display module in which a viewer's-side surface (display screen) of a liquid crystal display panel is formed into a curved shape. In this curved-surface-type liquid crystal display module, the display screen of the liquid crystal display panel is formed into a curved shape by using a rigid metal frame or a resin mold frame molded in a curved shape and by adhering a liquid crystal display panel to such a frame using a tape having a high adhesive strength, in general.

However, in such a general curved-surface-type liquid crystal display device, to maintain the metal frame or the resin mold frame in a curved shape (curved shape), it is necessary to form the frame having high rigidity by molding and hence, a weight or a layer thickness of the liquid crystal display module are increased. Further, the frame having a curved shape exhibits poor workability and pushes up a parts cost.

The present invention has been made to overcome the above-mentioned drawbacks of the related art, and it is an object of the present invention to provide a curved-surface-type liquid crystal display device (liquid crystal display module) suitable for reduction of thickness and weight of such a display device or such a display module.

The above-mentioned and other objects and novel features of the present invention will become apparent from the description of this specification and attached drawings.

To briefly explain the summary of typical inventions among inventions described in this specification, they are as follows.

(1) According to one aspect of the present invention, there is provided a liquid crystal display device which includes: a liquid crystal display panel which is formed by sandwiching liquid crystal between a first substrate and a second substrate; a first polarizer which is adhered to a viewer's-side surface of the liquid crystal display panel; a second polarizer which is adhered to a surface of the liquid crystal display panel on a side opposite to the viewer's-side surface of the liquid crystal display panel; and a frame which houses the liquid crystal display panel therein, wherein the liquid crystal display panel is formed into a curved shape in a direction that the viewer's-side surface of the liquid crystal display panel forms a convex surface or a concave surface in a state where the liquid crystal display panel is not housed in the frame.

(2) In the liquid crystal display device having the constitution (1), a planar shape of the liquid crystal display panel is formed into a rectangular shape having short sides and long sides, and the liquid crystal display panel is formed into a curved shape in a direction along the long sides of the liquid crystal display panel.

(3) In the liquid crystal display device having the constitution (1), the first polarizer is adhered to the viewer's-side surface of the liquid crystal display panel with a first adhesive layer interposed therebetween, and the second polarizer is adhered to the surface of the liquid crystal display panel on the side opposite to the viewer's-side surface of the liquid crystal display panel with a second adhesive layer which differs from the first adhesive layer in an adhesive strength interposed therebetween.

According to another aspect of the present invention, there is provided a manufacturing method of a liquid crystal display device which includes the steps of: (a) preparing a liquid crystal display panel which is formed by sandwiching liquid crystal between a first substrate and a second substrate; (b) adhering a first polarizer to a viewer's-side surface of the liquid crystal display panel with a first adhesive layer interposed therebetween; (c) adhering a second polarizer to a surface of the liquid crystal display panel on a side opposite to the viewer's-side surface of the liquid crystal display panel with a second adhesive layer having a higher adhesive strength than the first adhesive layer interposed therebetween; and (d) forming the liquid crystal display panel into a curved shape in a direction that the viewer's-side surface of the liquid crystal display panel is formed into a convex surface by applying heat treatment after performing the step (b) and the step (c).

(5) According to still another aspect of the present invention, there is provided a manufacturing method of a liquid crystal display device which includes the steps of: (a) preparing a liquid crystal display panel in which liquid crystal is sandwiched between a first substrate and a second substrate; (b) adhering a first polarizer to a surface of the liquid crystal display panel on a side opposite to a viewer's-side surface of the liquid crystal display panel with a first adhesive layer interposed therebetween; (c) adhering a second polarizer to the viewer's-side surface of the liquid crystal display panel with a second adhesive layer having a higher adhesive strength than the first adhesive layer interposed therebetween; and (d) forming the liquid crystal display panel into a curved shape in a direction that the surface of the liquid crystal display panel on a side opposite to the viewer's-side surface of the liquid crystal display panel is formed into a convex surface by applying heat treatment after performing the step (b) and the step (c).

(6) In the manufacturing method of a liquid crystal display device having the constitution (4) or (5), a planar shape of the liquid crystal display panel is formed into a rectangular shape having short sides and long sides, and the liquid crystal display panel is formed into a curved shape in a direction along the long sides of the liquid crystal display panel.

(7) In the manufacturing method of a liquid crystal display device having any one of the constitutions (4) to (6), the manufacturing method further includes a step of housing the liquid crystal display panel in a frame after performing the step (d).

To briefly explain advantageous effects acquired by typical inventions among the inventions disclosed in this specification, they are as follows.

According to the present invention, it is possible to provide a curved-surface liquid crystal display device suitable for reduction of thickness and weight of the display device.

### BRIEF DESCRIPTION OF THE DRAWINGS

FIG. 1 is a plan view showing the schematic constitution of a liquid crystal display module according to an embodiment 1 of the present invention;

FIG. 2 is a side view of the liquid crystal display module as viewed in the direction indicated by an arrow A in FIG. 1;

FIG. 3 is a side view of the liquid crystal display module according to the embodiment 1 of the present invention showing a state before a liquid crystal display panel is housed in a resin mold frame;

FIG. 4A to FIG. 4D are views showing manufacturing steps of the liquid crystal display module according to the embodiment 1 of the present invention;

FIG. 5A to FIG. 5C are views for explaining the mechanism of forming the liquid crystal display panel of the liquid crystal display module according to the embodiment 1 of the present invention into a curved shape, wherein FIG. 5A is a view showing a change in shape of a polarizer adhered to a CF substrate caused by heat treatment, FIG. 5B is a view showing a change in shape of a polarizer adhered to a TFT substrate caused by heat treatment, and FIG. 5C is a view showing a state of the liquid crystal display panel after heat treatment; and

FIG. 6 is a side view showing the schematic constitution of a liquid crystal display module according to an embodiment 2 of the present invention.

### DESCRIPTION OF THE PREFERRED EMBODIMENT

Embodiments of the present invention are explained in detail in conjunction with drawings hereinafter. Here, in all drawings for explaining the embodiments of the present invention, parts having identical functions are given same symbols, and their repeated explanations are omitted.

### Embodiment 1

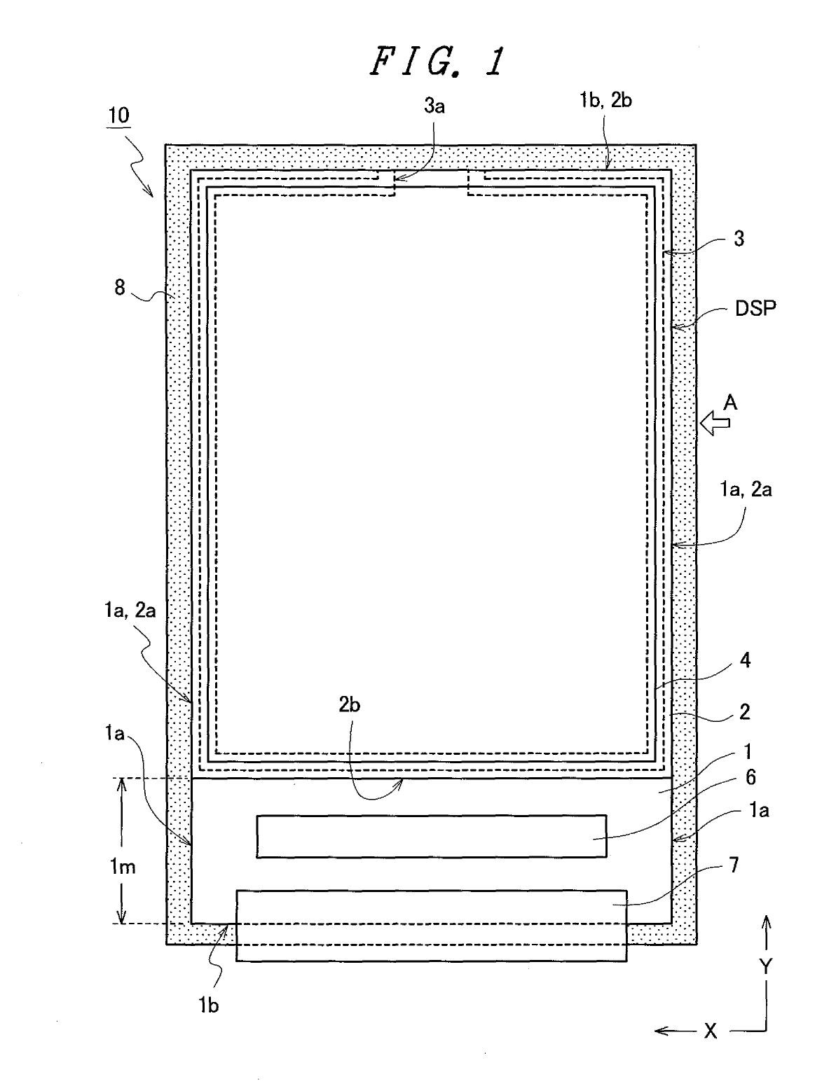

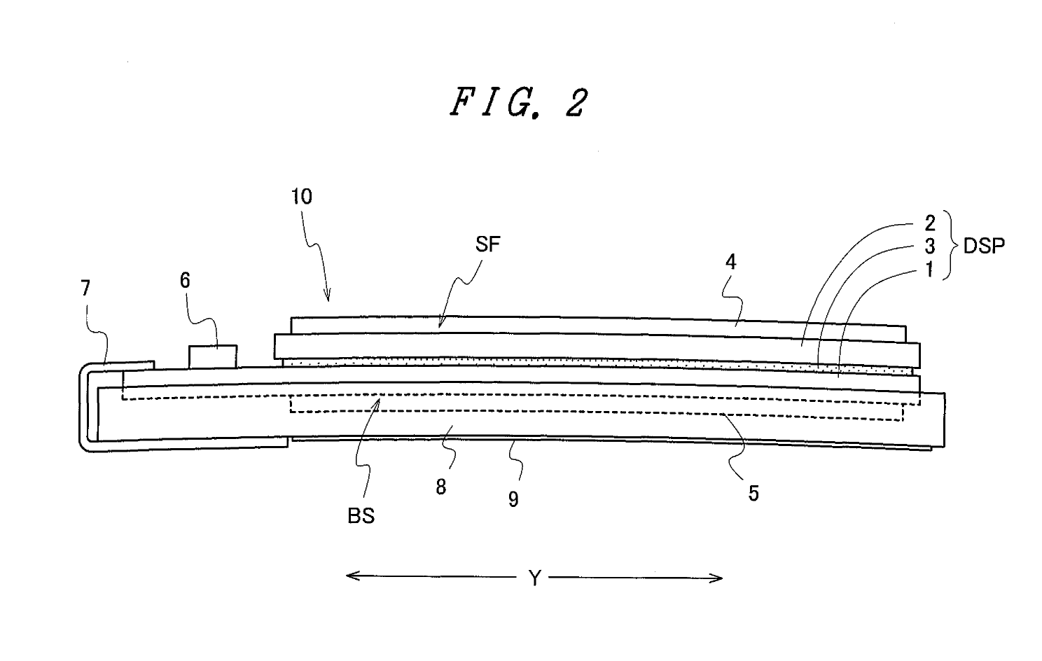

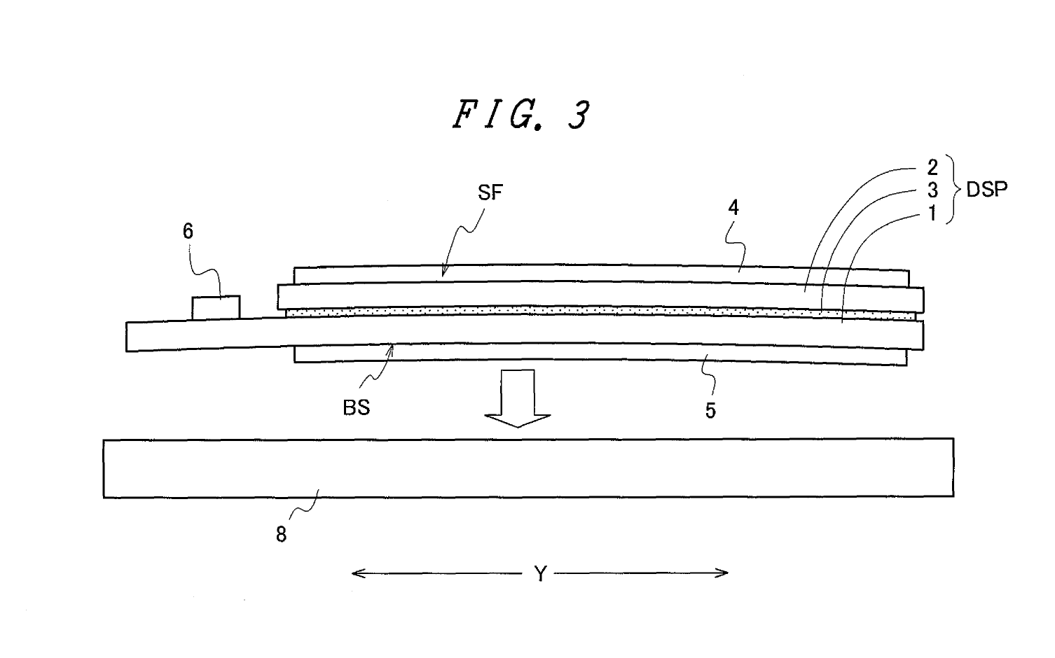

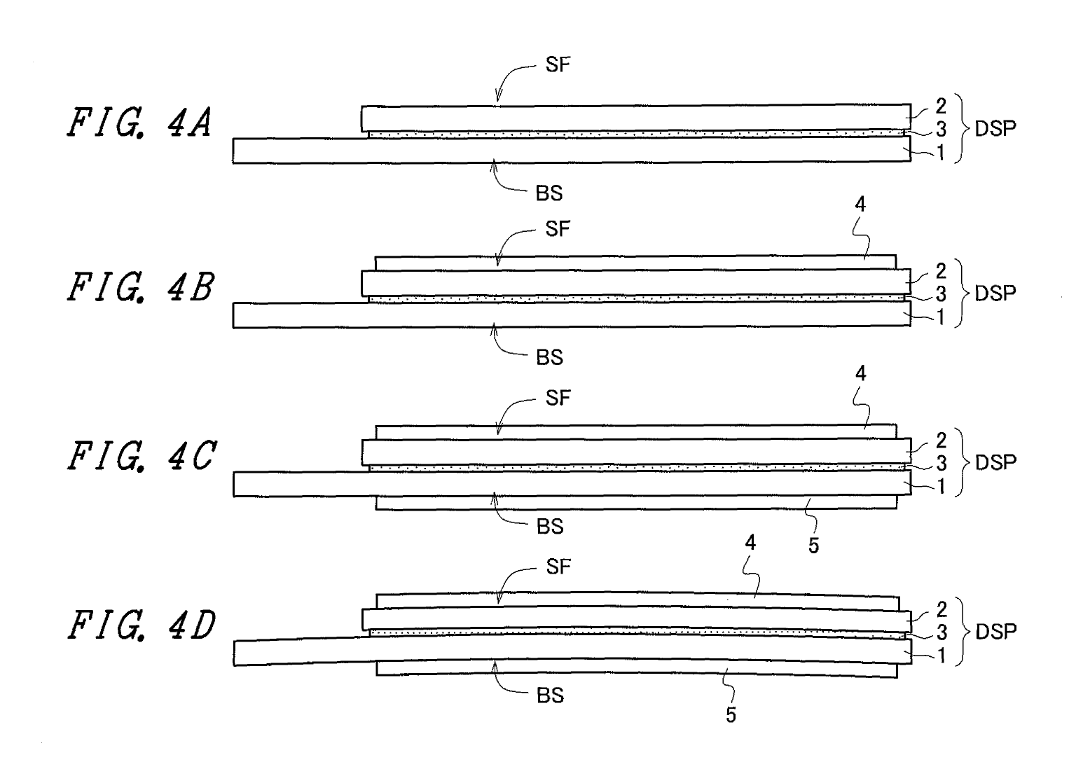

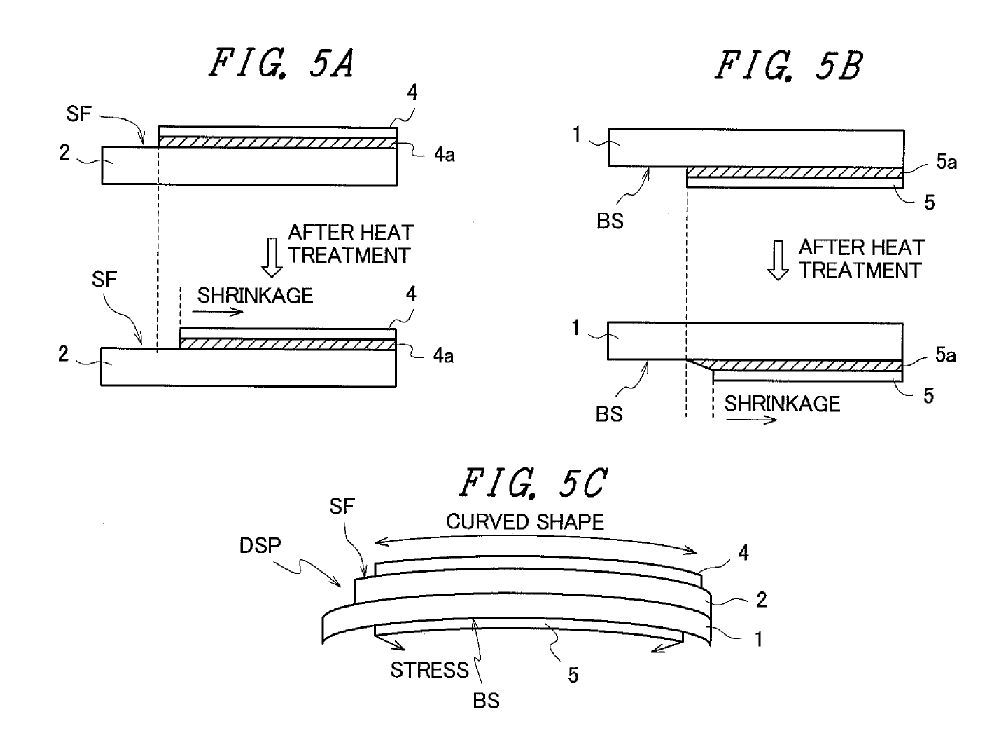

FIG. 1 to FIG. 5 are views of a liquid crystal display module (liquid crystal display device) according to the embodiment 1 of the present invention. FIG. 1 is a plan view showing the schematic constitution of the liquid crystal display module. FIG. 2 is a side view of the liquid crystal display module as viewed in the direction indicated by an arrow A in FIG. 1. FIG. 3 is a side view of the liquid crystal display module showing a state where a liquid crystal display panel is separated from a resin mold frame. FIG. 4A to FIG. 4D are views showing manufacturing steps of the liquid crystal display module. FIG. 5A to FIG. 5C are views for explaining the mechanism of forming the liquid crystal display panel of the liquid crystal display module into a curved shape, wherein FIG. 5A is a view showing a change in shape of a polarizer adhered to a CF substrate caused by heat treatment, FIG. 5B is a view showing a change in shape of a polarizer adhered to a TFT substrate caused by heat treatment, and FIG. 5C is a view showing a state of the liquid crystal display panel after heat treatment.

Here, for facilitating the understanding of the constitution shown in FIG. 3, a flexible printed circuit board 7 and a reflection sheet 9 which are shown in FIG. 2 are omitted in FIG. 3.

A liquid crystal display module 10 of this embodiment is a TFT-type liquid crystal display module having a miniaturized liquid crystal display panel DSP for color display in which the number of pixels is approximately 240×320×3. The liquid crystal display module 10 is used as a display part of portable equipment such as a mobile phone.

As shown in FIG. 1 and FIG. 2, the liquid crystal display module 10 of this embodiment includes a liquid crystal display panel DSP having a viewer's-side surface SF (hereinafter, referred to as a display screen SF) on one side thereof; a backlight unit which is arranged on a surface BS of the liquid crystal display panel DSP on a side opposite to the display screen SF (hereinafter, referred to as a back surface BS), a frame 8 which houses and supports the liquid crystal display panel DSP and the backlight unit on a back surface BS side of the liquid crystal display panel DSP, and a flexible printed circuit board (FPC) 7 which is connected to the liquid crystal display panel DSP. The liquid crystal display module 10 further includes a polarizer 4 which is adhered to the display screen (viewer's-side surface) SF of the liquid crystal display panel DSP, and a polarizer 5 which is adhered to the back surface (a surface on a side opposite to the viewer's-side surface) BS of the liquid crystal display panel DSP. As the frame 8, a resin white mold frame is used, for example.

The liquid crystal display panel DSP includes: a first substrate (hereinafter, referred to as a TFT substrate) 1 on which pixel electrodes, thin film transistors and the like are formed; a second substrate (hereinafter, referred to as a CF substrate) 2 on which color filters and the like are formed; a sealing material 3 which is formed between the TFT substrate 1 and the CF substrate 2 so as to adhere the TFT substrate 1 and the CF substrate 2 to each other; a liquid crystal filling port 3a which is formed in a portion of the sealing material 3; a liquid crystal layer which is made of liquid crystal filled and sealed in a region defined by the sealing material 3 between the TFT substrate 1 and the CF substrate 2; a liquid crystal plug material (not shown in the drawing) for closing the liquid crystal filling port 3a; a semiconductor chip 6 on which a drive circuit for driving and controlling the liquid crystal display panel DSP is mounted; and a display region on which a plurality of pixels are arranged in a matrix array. Each of the plurality of pixels includes a pixel electrode and a counter electrode.

The TFT substrate 1 and the CF substrate 2 are formed of a transparent insulation substrate respectively. In this embodiment, a glass substrate is used for forming the TFT substrate 1 and the CF substrate 2, for example. As the sealing material 3, for example, a heat curing epoxy resin material is used.

Further, provided that a material for forming the TFT substrate 1 and the CF substrate 2 exhibits insulation property, the material is not limited to glass, and a plastic material or the like may also be used.

Here, the liquid crystal display panel DSP of this embodiment is an IPS-type liquid crystal display panel. In the IPS-type liquid crystal display panel, the counter electrodes are formed on a TFT substrate 1 side together with the pixel electrodes. On the other hand, in a TN-type or VA-type liquid crystal display panel, counter electrodes are formed on a CF substrate side different from pixel electrodes. In FIG. 1, numeral 8 indicates a reflection sheet.

The TFT substrate 1 and the CF substrate 2 have a planar quadrangular shape (planar rectangular shape) respectively. For example, the TFT substrate 1 and the CF substrate 2 have a planar rectangular shape having long sides (1a, 2a) and short sides (1b, 2b). The TFT substrate 1 and the CF substrate 2, assuming two directions which orthogonally intersect with each other on the same plane as the X direction (first direction) and the Y direction (second direction), have the substantially same size in the X direction and differ from each other in size in the Y direction such that the TFT substrate 1 is larger than the CF substrate in size. That is, a length of the long side 1a of the TFT substrate 1 is set larger than a length of the long side 2a of the CF substrate 2 thus forming a region where the TFT substrate 1 and the CF substrate 2 do not overlap with each other (hereinafter, referred to as a non-overlapping region) 1m on one of two short sides 1b which are positioned opposite to each other. On the non-overlapping region 1m of the TFT substrate 1, a semiconductor chip 6 is mounted. Further, a plurality of external connection terminals (not shown in the drawing) are arranged on the TFT substrate 1 along one short side (the short side on the non-overlapping region 1m side) 1b of the TFT substrate 1. To the plurality of respective external connection terminals, one ends of the plurality of respective lines which are arranged on the flexible printed circuit board are electrically and mechanically connected via an anisotropic conductive film which is referred to as an ACF, for example.

The flexible printed circuit board 7 has one end thereof fixed to the short side 1b of the TFT substrate 1 on the non-overlapping region 1m side, and has another end thereof folded such that another end of the flexible printed circuit board 7 is positioned on a back-surface-side of the TFT substrate 1 opposite to a liquid crystal layer side.

Here, the planar shape of the liquid crystal display panel DSP corresponds to the planar shape of the TFT substrate 1 where a length of the long side 1a is set larger than a length of the long side 2a of the CF substrate 2. In this embodiment, the planar shape of the TFT substrate 1 is rectangular and hence, the planar shape of the liquid crystal display panel DSP is also rectangular.

As shown in FIG. 5A to FIG. 5C, the polarizers 4, 5 respectively have an adhesive layer (4a, 5a). The polarizer 4 is adhered to a surface of the CF substrate 2 on a side opposite to a liquid-crystal-layer-side surface of the CF substrate 2 with the adhesive layer 4a interposed therebetween (see FIG. 5A), and the polarizer 5 is adhered to a surface of the TFT substrate 1 on a side opposite to a liquid-crystal-layer-side surface of the TFT substrate 1 with the adhesive layer 5a interposed therebetween (see FIG. 5B).

Here, a surface of the CF substrate 2 on a side opposite to the liquid-crystal-layer-side surface of the CF substrate 2 corresponds to the display screen (viewer's-side surface) of the liquid crystal display panel DSP, and a surface of the TFT substrate 1 on a side opposite to the liquid-crystal-layer-side surface of the TFT substrate 1 corresponds to the back surface (a surface on a side opposite to the viewer's-side surface) BS of the liquid crystal display panel DSP.

An adhesive strength of the adhesive layer 5a used for adhesion of the polarizer 5 and an adhesive strength of the adhesive layer 4a used for adhesion of the polarizer 4 differ from each other. Although the adhesive strength relationship is not limited, in this embodiment, for example, the adhesive strength of the adhesive layer 5a of the polarizer 5 which is adhered to the back surface (the surface of the TFT substrate 1 on a side opposite to the liquid-crystal-layer-side surface of the TFT substrate 1) BS of the liquid crystal display panel DSP is set larger (higher) than the adhesive strength-of the adhesive layer 4a of the polarizer 4 which is adhered to the display screen (the surface of the CF substrate 2 on a side opposite to the liquid-crystal-layer-side surface of the CF substrate 2) SF of the liquid crystal display panel DSP.

As shown in FIG. 2, the liquid crystal display module 10 of this embodiment is a curved-shape-type liquid crystal display module where the display screen (viewer's-side surface) SF of the liquid crystal display panel DSP is formed into a curved shape.

The liquid crystal display panel DSP is formed into a curved shape (warped shape) in the direction that the display screen SF of the liquid crystal display panel DSP has a convex surface or a concave surface. The display screen SF of the liquid crystal display panel DSP has a convex surface or a concave surface due to this forming of the liquid crystal display panel DSP into a curved shape. For example, in this embodiment, the liquid crystal display panel DSP is formed into a curved shape in the direction that the display screen SF of the liquid crystal display panel DSP forms a convex surface, and the display screen SF of the liquid crystal display panel DSP has a convex curved surface due to forming of the display screen SF into a curved shape. However, this embodiment is not limited to such a curved shape.

The liquid crystal display panel DSP of this embodiment has a rectangular planar shape having long sides and short sides, and is formed into a curved shape in the direction (Y direction in FIG. 2) along the long sides of the planar shape.

The liquid crystal display panel DSP is formed into a curved shape by a bending stress generated due to the difference in adhesive strength between the adhesive layer 4a (see FIG. 5A) of the polarizer 4 which is adhered to the display screen SF of the liquid crystal display panel DSP and the adhesive layer 5a (see FIG. 5B) of the polarizer 5 which is adhered to the back surface BS of the liquid crystal display panel DSP. As shown in FIG. 3, the liquid crystal display panel DSP is formed into a curved shape in the direction that the display screen SF of the liquid crystal display panel DSP forms a convex surface or a concave surface (in this embodiment, a convex surface) in a state where the liquid crystal display panel DSP is not housed in the frame 8.

On the other hand, as shown in FIG. 3, the frame 8 has a flat shape in a state that the liquid crystal display panel DSP is not housed in the frame 8 and, as shown in FIG. 2, the frame 8 is formed into a curved shape by housing the liquid crystal display panel DSP therein. The housing of the liquid crystal display panel. DSP in the frame 8 is carried out by adhering the liquid crystal display panel DSP to the frame 8 using a tape having a high adhesive strength and hence, in housing the liquid crystal display panel DSP in the frame 8, the frame 8 is formed into a curved shape following the (corresponding to) the liquid crystal display panel DSP in a curved shape. Accordingly, to form the frame 8 into a curved shape following the liquid crystal display panel DSP in a curved shape, the frame 8 having flexibility which is deformable following the liquid crystal display panel DSP in a curved shape is selected. In this embodiment, a resin mold frame is used as the frame 8. With the use of the resin mold frame, it is possible to easily impart the flexibility to the frame 8 such that the frame 8 is deformed following the liquid crystal display panel DSP in a curved shape in housing the liquid crystal display panel DSP in the frame 8.

As described previously, the display screen SF of the liquid crystal display panel DSP is formed into a convex or concave curved surface by forming the liquid crystal display panel DSP into a curved shape. In this embodiment, the liquid crystal display panel DSP is formed into a curved shape such that the display screen SF has a convex curved shape. The liquid crystal display panel DSP is formed into a curved shape by a bending stress generated due to the difference in adhesive strength between the adhesive layer 4a of the polarizer 4 which is adhered to the display screen (the surface of the CF substrate 2 on the side opposite to the liquid-crystal-layer-side surface of the CF substrate 2) SF of the liquid crystal display panel DSP and the adhesive layer 5a of the polarizer 5 which is adhered to the back surface (a surface of the TFT surface 1 on the side opposite to the liquid-crystal—layer-side surface of the TFT substrate 1) BS of the liquid crystal display panel DSP. The curving mechanism of the liquid crystal display panel DSP is explained in conjunction with FIG. 5 hereinafter.

Firstly, with respect to the polarizer 4 which is adhered to the surface (SF) of the CF substrate 2 on the side opposite to the liquid-crystal-layer-side surface of the CF substrate 2, as shown in FIG. 5A, the adhesive strength of the adhesive layer 4a is low and hence, the adhesive layer 4a is also moved along with the shrinkage of the polarizer 4 (a phenomenon that the polarizer 4 shrinks in the direction toward the center from a periphery thereof) caused by the heat treatment. Accordingly, a stress generated by the shrinkage of the polarizer 4 can be alleviated.

On the other hand, with respect to the polarizer 5 which is adhered to the surface (BS) of the TFT substrate 1 on the side opposite to the liquid-crystal-layer-side surface of the TFT substrate 1, the adhesive strength of the adhesive layer 5a is large and hence, although the polarizer 5 shrinks due to the heat treatment (a phenomenon that the polarizer 5 shrinks in the direction toward the center from the periphery thereof), the adhesive layer 5a may be elongated but is not moved. Accordingly, the stress generated by the shrinkage of the polarizer 5 remains as it is.

As described above, the stress generated by the shrinkage of the polarizer 4 on a side of the CF substrate 2 is alleviated and the stress generated by the shrinkage of the polarizer 5 on a side of the TFT substrate 1 remains and hence, a bending stress is applied to the whole liquid crystal display panel DSP thus forming the liquid crystal display panel DSP into a curved shape.

Accordingly, as explained in this embodiment, for forming the liquid crystal display panel DSP into a curved shape (warped shape) in the direction that the display screen SF forms a convex surface, the adhesive strength of the adhesive layer 5a of the polarizer 5 which is adhered to the back surface BS is set larger (higher) than the adhesive strength of the adhesive layer 4a of the polarizer 4 which is adhered to the display screen SF, the adhesive strength of the adhesive layer 4a of the polarizer 4 is set to an adhesive strength with which the adhesive layer 4a can be moved along with the shrinkage of the polarizer 4 caused by the heat treatment, and the adhesive strength of the adhesive layer 5a of the polarizer 5 is set to an adhesive strength with which the adhesive layer 5a is elongated along with the shrinkage of the polarizer 5 caused by the heat treatment but is not moved.

Next, the manufacture of the liquid crystal display module 10 of this embodiment is explained in conjunction with FIG. 4. Firstly, the liquid crystal display panel DSP shown in FIG. 4A is prepared. As described above, the liquid crystal display panel DSP includes: the TFT substrate 1; the CF substrate 2, the sealing material 3 which is formed between the TFT substrate 1 and the CF substrate 2 so as to adhere the TFT substrate 1 and the CF substrate 2 to each other; the liquid crystal filling port 3a which is formed in a portion of the sealing material 3; the liquid crystal layer which is made of liquid crystal filled and sealed in the region defined the sealing material 3 between by the TFT substrate 1 and the CF substrate 2; the liquid crystal plug material (not shown in the drawing) for closing the liquid crystal filling port 3a, and the like.

Next, the polarizer 4 having the adhesive layer 4a on one surface thereof is prepared and, thereafter, as shown in FIG. 4B, the polarizer 4 is adhered to the display screen SF (the surface of the CF substrate 2 on a side opposite to the liquid-crystal-layer-side surface of the CF substrate 2) of the liquid crystal display panel DSP with the adhesive layer 4a interposed therebetween.

Next, the polarizer 5 having the adhesive layer 5a on one surface thereof is prepared and, thereafter, as shown in FIG. 4C, the polarizer 5 is adhered to the back surface BS (the surface of the TFT substrate 1 on a side opposite to the liquid-crystal-layer-side surface of the TFT substrate 1) of the liquid crystal display panel DSP with the adhesive layer 5a interposed therebetween.

In this embodiment, the polarizer 4 is adhered to the liquid crystal display panel DSP prior to the adhesion of the polarizer 5. However, the polarizer 5 may be adhered to the liquid crystal display panel DSP prior to the adhesion of the polarizer 4.

Next, after the polarizer 4 and the polarizer 5 are adhered to the liquid crystal display panel DSP, the heat treatment is applied to the liquid crystal display panel DSP so as to form the liquid crystal display panel DSP into a curved shape in the direction that the display screen SF of the liquid crystal display panel DSP forms a convex surface or a concave surface. In this embodiment, the adhesive strength of the adhesive layer 5a of the polarizer 5 which is adhered to the back surface BS of the liquid crystal display panel DSP is set higher than the adhesive strength of the adhesive layer 4a of the polarizer 4 which is adhered to the display screen SF of the liquid crystal display panel DSP. Accordingly, the liquid crystal display panel DSP is formed into a curved shape in the direction that the display screen SF of the liquid crystal display panel. DSP forms a convex surface whereby the display screen SF of the liquid crystal display panel DSP forms a convex curved surface along with the forming of the liquid crystal display panel DSP into a curved shape.

Next, the semiconductor chip 6 is mounted on the non-overlapping region 1m of the TFT substrate 1 and, thereafter, the plurality of external connection terminals which are arranged on the non-overlapping region 1m of the TFT substrate 1 and the respective one sides of the plurality of lines on the flexible printed circuit board 7 are electrically and mechanically connected to each other using an anisotropic conductive film which is referred to as the ACF, for example. Thereafter, the liquid crystal display panel DSP is arranged on a backlight unit which is manufactured separately. Thereafter, the liquid crystal display panel DSP is housed in the frame 8 together with the backlight unit thus substantially completing the manufacture of the liquid crystal display module of this embodiment.

In the conventional curved-surface-type liquid crystal display module, the display screen of the liquid crystal display panel is formed into a curved shape by using a rigid metal frame or a resin mold frame molded in a curved shape and by adhering a liquid crystal display panel to such a frame using a tape having a high adhesive strength, in general.

However, in such a general curved-surface-type liquid crystal display device, to maintain the metal frame or the resin mold frame in a curved shape (bent shape), it is necessary to form the frame having high rigidity by molding and hence, a weight or a layer thickness of the liquid crystal display module are increased. Further, the frame having a curved shape exhibits poor workability and pushes up a parts cost.

To the contrary, according to this embodiment, the liquid crystal display panel DSP is formed into a curved shape (warped shape) in the direction that the display screen SF of the liquid crystal display panel DSP forms a convex surface in a state where the liquid crystal display panel DSP is not housed in the frame 8, and the display screen SF of the liquid crystal display panel DSP forms a convex curved surface due to the forming of the liquid crystal display panel DSP into a curved shape. The liquid crystal display panel DSP is formed into a curved shape by a bending stress generated due to the difference in adhesive strength between the adhesive layer 4a of the polarizer 4 which is adhered to the display screen SF of the liquid crystal display panel DSP and the adhesive layer 5a of the polarizer 5 which is adhered to the back surface BS of the liquid crystal display panel DSP.

Due to such a constitution, it is unnecessary to form the frame 8 for housing the liquid crystal display panel DSP therein into a curved shape by molding and, further, it is also unnecessary to form the frame 8 having high rigidity by molding to maintain the curved shape of the frame 8 and hence, it is possible to realize the reduction of thickness and weight of the liquid crystal display module 10.

That is, according to this embodiment, it is possible to provide the curved-surface-type liquid crystal display module which is suitable for realizing the reduction of thickness and weight.

Further, it is unnecessary to form the frame 8 into a curved shape by molding and hence, it is possible to suppress the increase of parts cost whereby it is possible to provide a curved-surface-type liquid crystal display module which is suitable for realizing the reduction of cost in addition to the reduction of thickness and the reduction of weight.

Here, in this embodiment, the explanation has been made with respect to the constitution where the frame 8 is also formed into a curved shape following the liquid crystal display panel DSP in a curved shape. However, by improving the manner of fixing the frame 8 and the liquid crystal display panel DSP to each other, the frame 8 may maintain a flat shape without following the liquid crystal display panel DSP in a curved shape.

Further, in this embodiment, as the frame 8 for housing the liquid crystal display panel DSP therein, the frame which has a flat shape before the frame houses the liquid crystal display panel DSP therein is used. However, a frame which is preliminarily formed into a curved shape in accordance with the curved shape of the liquid crystal display panel DSP may be used. In this case, the liquid crystal display panel DSP is already formed into a curved shape before the liquid crystal display panel DSP is housed in the frame 8. Accordingly, different from the conventional case where a liquid crystal display panel is formed into a curved shape along the curved shape of the frame, it is unnecessary to form a frame having high rigidity by molding. Also in this case, it is possible to realize the reduction of thickness and weight of the liquid crystal display module 10.

### Embodiment 2

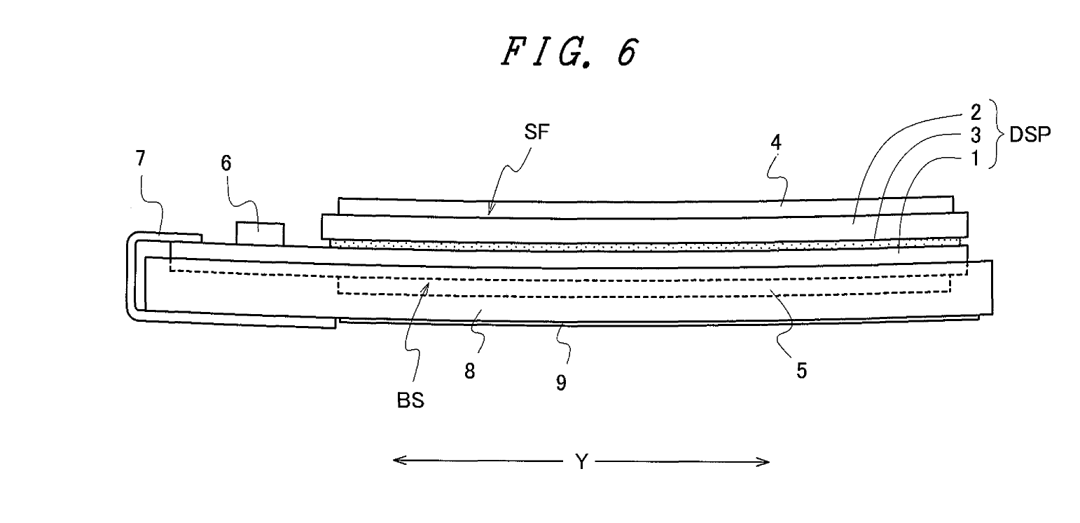

FIG. 6 is a side view showing the schematic constitution of a liquid crystal display module according to an embodiment 2 of the present invention.

The liquid crystal display module 10 according to the embodiment 2 basically has the substantially same constitution as the above-mentioned liquid crystal display module 10 according to the embodiment 1, and the constitution which makes this embodiment differ from the embodiment 1 is as follows.

That is, in the above-mentioned embodiment 1, as shown in FIG. 2, the display screen SF of the liquid crystal display panel DSP has a convex curved surface.

To the contrary, in this embodiment, as shown in FIG. 6, the display screen SF of the liquid crystal display panel DSP has a concave curved surface. Such a concave curved surface is generated by forming the liquid crystal display panel DSP into a curved shape in the direction that a display screen SF of the liquid crystal display panel DSP is formed into a curved shape. For forming the liquid crystal display panel DSP into a curved shape (warped shape) in the direction that the display screen SF forms a concave curved surface, an adhesive strength of an adhesive layer 4a of a polarizer 4 which is adhered to a display screen SF is set higher (stronger) than an adhesive strength of an adhesive layer 5a of a polarizer 5 which is adhered to a back surface BS, the adhesive strength of the adhesive layer 5a of the polarizer 5 is set to an adhesive strength with which the adhesive layer 5a can move along with the shrinkage of the polarizer 5 caused by heat treatment, and the adhesive strength of the adhesive layer 4a of the polarizer 4 is set to an adhesive strength with which the adhesive layer 4a is elongated along with the shrinkage of the polarizer 4 caused by heat treatment but is not moved. That is, the relationship between the function of the adhesive layer 4a of the polarizer 4 and the function of the adhesive layer 5a of the polarizer 5 adopted by the above-mentioned embodiment 1 is reversed in this embodiment.

In the manufacture of the liquid crystal display module 10 of the embodiment 2, after carrying out a step of adhering the polarizer 4 to the display screen SF (a surface of a CF substrate 2 on a side opposite to a liquid-crystal-layer-side surface of the CF substrate 2) of the liquid crystal display panel DSP with the adhesive layer 4a interposed therebetween, and a step of adhering the polarizer 5 to the back surface BS (a surface of the TFT substrate 1 on a side opposite to a liquid-crystal-layer-side surface of the TFT substrate 1) of the liquid crystal display panel DSP with the adhesive layer 5a interposed therebetween, the heat treatment is applied to the liquid crystal display panel DSP thus forming the liquid crystal display panel DSP into a curved shape in the direction that the display screen SF of the liquid crystal display panel DSP forms a convex surface or a concave surface. In this embodiment, the adhesive strength of the adhesive layer 4a of the polarizer 4 which is adhered to the display screen SF of the liquid crystal display panel DSP is higher than the adhesive strength of the adhesive layer 5a of the polarizer 5 which is adhered to the back surface BS of the liquid crystal display panel DSP. Accordingly, the liquid crystal display panel DSP is formed into a curved shape in the direction that the display screen SF of the liquid crystal display panel DSP forms a concave surface, and the display screen SF has a concave curved surface along with the forming of the liquid crystal display panel DSP into a curved shape.

Also according to the embodiment 2, in the substantially same manner as the above-mentioned embodiment 1, it is possible to provide a curved-surface-type liquid crystal display module which is suitable for realizing the reduction of thickness and weight. Further, it is possible to provide a curved-surface-type liquid crystal display module which is suitable for realizing the reduction of cost in addition to the reduction of thickness and weight.

Here, also in this embodiment, as shown in FIG. 6, the frame 8 is formed into a curved shape following the liquid crystal display panel DSP in a curved shape. However, by improving the manner of fixing the frame 8 and the liquid crystal display panel DSP to each other, the frame 8 may maintain a flat shape without following the liquid crystal display panel DSP in a curved shape.

Although the present invention made by the inventors has been specifically explained in conjunction with the embodiments heretofore, it is needless to say that the present invention is not limited to the above-mentioned embodiments and various modifications are conceivable without departing from the gist of the present invention.

What is claimed is:

1. A liquid crystal display device comprising:
a liquid crystal display panel which is formed by sandwiching liquid crystal between a first substrate and a second substrate;
a first polarizer which is adhered to a viewer's-side surface of the liquid crystal display panel;
a second polarizer which is adhered to a surface of the liquid crystal display panel on a side opposite to the viewer's-side surface of the liquid crystal display panel; and
a frame which houses the liquid crystal display panel therein, wherein
the liquid crystal display panel is formed into a curved shape in a direction that the viewer's-side surface of the liquid crystal display panel forms a convex surface or a concave surface in a state where the liquid crystal display panel is not housed in the frame.

2. A liquid crystal display device according to claim 1, wherein a planar shape of the liquid crystal display panel is formed into a rectangular shape having short sides and long sides, and
the liquid crystal display panel is formed into a curved shape in a direction along the long sides of the liquid crystal display panel.

3. A liquid crystal display device according to claim 1, wherein the first polarizer is adhered to the viewer's-side surface of the liquid crystal display panel with a first adhesive layer interposed therebetween, and
the second polarizer is adhered to the surface of the liquid crystal display panel on the side opposite to the viewer's-side surface of the liquid crystal display panel with a second adhesive layer which differs from the first adhesive layer in an adhesive strength interposed therebetween.

4. A liquid crystal display device according to claim 2, wherein the first polarizer is adhered to the viewer's-side surface of the liquid crystal display panel with a first adhesive layer interposed therebetween, and
the second polarizer is adhered to the surface of the liquid crystal display panel on the side opposite to the viewer's-side surface of the liquid crystal display panel with a second adhesive layer which differs from the first adhesive layer in an adhesive strength interposed therebetween.

5. A manufacturing method of a liquid crystal display device comprising the steps of:
(a) preparing a liquid crystal display panel in which liquid crystal is sandwiched between a first substrate and a second substrate;
(b) adhering a first polarizer to a viewer's-side surface of the liquid crystal display panel with a first adhesive layer interposed therebetween;
(c) adhering a second polarizer to a surface of the liquid crystal display panel on a side opposite to the viewer's-side surface of the liquid crystal display panel with a second adhesive layer having a higher adhesive strength than the first adhesive layer interposed therebetween; and
(d) forming the liquid crystal display panel into a curved shape in a direction that the viewer's-side surface of the liquid crystal display panel is formed into a convex surface by applying heat treatment after performing the step (b) and the step (c).

6. A manufacturing method of a liquid crystal display device according to claim 5, wherein a planar shape of the liquid crystal display panel is formed into a rectangular shape having short sides and long sides, and
the liquid crystal display panel is formed into a curved shape in a direction along the long sides of the liquid crystal display panel.

7. A manufacturing method of a liquid crystal display device according to claim 5, further comprising a step of housing the liquid crystal display panel in a frame after performing the step (d).

8. A manufacturing method of a liquid crystal display device according to claim 6, further comprising a step of housing the liquid crystal display panel in a frame after performing the step (d).

9. A manufacturing method of a liquid crystal display device comprising the steps of:
(a) preparing a liquid crystal display panel in which liquid crystal is sandwiched between a first substrate and a second substrate;
(b) adhering a first polarizer to a surface of the liquid crystal display panel on a side opposite to a viewer's-side surface of the liquid crystal display panel with a first adhesive layer interposed therebetween;
(c) adhering a second polarizer to the viewer's-side surface of the liquid crystal display panel with a second adhesive layer having a higher adhesive strength than the first adhesive layer interposed therebetween; and
(d) forming the liquid crystal display panel into a curved shape in a direction that the viewer's-side surface of the liquid crystal display panel is formed into a concave surface by applying heat treatment after performing the step (b) and the step (c).

10. A manufacturing method of a liquid crystal display device according to claim 9, wherein a planar shape of the liquid crystal display panel is formed into a rectangular shape having short sides and long sides, and
the liquid crystal display panel is formed into a curved shape in a direction along the long sides of the liquid crystal display panel.

11. A manufacturing method of a liquid crystal display device according to claim 9, further comprising a step of housing the liquid crystal display panel in a frame after performing the step (d).

12. A manufacturing method of a liquid crystal display device according to claim 10, further comprising a step of housing the liquid crystal display panel in a frame after performing the step (d).
